(19) United States
(12) Patent Application Publication
(10) Pub. No.: US 2012/0313022 A1
(43) Pub. Date: Dec. 13, 2012

(54) SOLENOID VALVE WITH PLUNGER STAGE FOR CONTROLLING A FLUID

(75) Inventor: Pascal Godbillon, Heilbronn (DE)

(73) Assignee: ROBERT BOSCH GMBH, STUTTGART (DE)

(21) Appl. No.: 13/580,698

(22) PCT Filed: Feb. 9, 2011
(86) PCT No.: PCT/EP11/51862

§ 371 Date: Aug. 23, 2012

(30) Foreign Application Priority Data
Feb. 23, 2010 (DE) 10 2010 002 216.0

(51) Int. Cl. F16K 31/02

(52) U.S. Cl. 251/129.15

(57) ABSTRACT

A solenoid valve for controlling a fluid includes an armature and a pole core. A working gap is provided between the armature and the pole core. The solenoid valve further includes a valve member, which is connected to the armature and can be moved together with the armature, and a valve body with a passage opening on which a valve seat is formed. The valve member opens and closes the passage opening on the valve seat. The solenoid valve also includes a restoring element which exerts a restoring force on the valve member to restore the valve member into a closed state. The armature has a central passage hole for receiving the valve member and the restoring element. The solenoid valve further includes a plunger stage which is formed between the pole core and the armature.

The present invention relates to a de-energizably closed solenoid valve having a plunger stage for controlling a fluid.

De-energizably closed solenoid valves for controlling a fluid are known from the prior art in different embodiments, in particular for example as outlet valves for ABS, TCS and ESP devices in motor vehicles. These solenoid valves comprise a valve member, which is connected to the armature, and a pole core. A restoring element is provided between the pole core and the armature. The valve member opens up a through-going orifice in a valve seat and subsequently closes off said through-going orifice again. A solenoid valve of this type is known, for example from DE 10 2007 031 981 A1.

### DISCLOSURE OF THE INVENTION

The solenoid valve in accordance with the invention for controlling a fluid having the features of claim 1 comprises in contrast the advantage that the magnetic force path is embodied in such a manner that the solenoid valve can be better adjusted over a large stroke range. This is achieved in accordance with the invention by virtue of the fact that the solenoid valve for controlling a fluid comprises an armature, a pole core, wherein a working gap is provided between the armature and the pole core, and a valve member that is connected to the armature and can move together with the armature. The solenoid valve comprises in addition a valve body having a through-going orifice, on which is embodied a valve seat, wherein the valve member opens up and closes off the through-going orifice on the valve seat, and a restoring element that exerts a restoring force on the valve member in order to restore the valve member to a closed state, wherein the armature comprises a central through-going bore for receiving the valve member and the restoring element. In addition, the solenoid valve comprises a plunger stage embodied between the pole core and the armature. In particular, in addition to a sufficiently high magnetic force when the solenoid valve is closed, a substantially linear magnetic force path is achieved over the entire valve stroke by means of the plunger stage, which results in a considerably improved adjustability of the solenoid valve.

The subordinate claims illustrate preferred embodiments of the invention.

In accordance with a preferred embodiment of the invention the plunger stage comprises a plunger stage cutout and a plunger stage element. In a further advantageous embodiment of the invention the armature, the valve member, the restoring element and a plunger form a pre-assemblable armature assembly, wherein the plunger stage element is arranged on the plunger and the plunger stage cutout is embodied on the armature by virtue of an end face-side cutout. As a consequence, a compact armature assembly having an integrated plunger stage is achieved that renders possible a cost-effective assembly process and also an exact adjustment facility for compensating tolerances in shorter cycle times. The simple design and generous tolerance specifications render it possible to manufacture the plunger stage element as a cost-effective individual mass-produced part using mass production technology.

Preferably the plunger stage element is connected to the plunger by means of a press-fit connection. As a consequence, it is possible to achieve an operationally reliable attachment in a simple manner where the expenditure on the devices and tools is minimized with regard to the time and costs involved. In addition, the concentricity tolerance between the outer diameter of the plunger stage element and the inner diameter of the plunger stage cutout on the armature is subjected to a considerably shortened tolerance chain and is in essence merely dependent upon the guide of the plunger. Any tilting or possible radial displacement of the armature with respect to the pole core has as a consequence no influence on the centering of the plunger stage element. The plunger is in addition preferably produced from a material that cannot be magnetized, in order not to adversely affect the magnetic circuit by virtue of a shunt between the pole core, the plunger and the armature.

In accordance with a preferred embodiment of the invention the solenoid valve in addition comprises a resilient element that is arranged between the pole core and the armature. By virtue of progressive resilient force of the resilient element, which force closes the valve, and in cooperation with the restoring element, the remaining progressive change of the magnetic force upon actuating the solenoid valve can be compensated for in a simple manner. As a consequence, the adjustability of the solenoid valve is considerably improved. The resilient element can preferably be embodied as a plate spring or a disk spring.

In a further advantageous embodiment of the invention, the resilient element is part of the pre-assembled armature assembly. As a consequence it is possible to simultaneously adjust the resilient element in cooperation with the restoring element and to finally assemble the solenoid valve in a time- and cost-minimizing manner with comparatively little expenditure with regard to the devices and tools used.

Preferably the plunger stage comprises a double plunger stage or a cone plunger stage. These plunger stage geometries render it possible to achieve the desired plunger stage function in a particularly compact installation volume without narrow tolerance specifications of the individual plunger stage parts.

In accordance with a preferred embodiment of the invention a contact surface of the pole core is embodied in a spherical manner in the direction towards the plunger stage element. Any possible skew position of the pole core in the housing can be compensated for by virtue of this design of said contact surface and any resulting tilting of the armature assembly can be prevented.

In a further advantageous embodiment the solenoid valve comprises an impact disk for deflecting fluid when the solenoid valve is open, wherein a part region of the valve member is guided through a central orifice in the impact disk. The impact disk causes the fluid flow to deflect by 180° in the opposite direction to the flow direction of the inflowing fluid and is used as an impact protection for the armature.

Preferably the plunger stage cutout is embodied in a tapered manner, in particular in a conical manner. It is further preferred that the plunger stage element comprises a concave surface that is directed towards the armature. These provide the free spaces that are sufficient when the solenoid valve is open into which the resilient disk can deform. In addition, the volume of the working gap is hereby only slightly enlarged and thus any impairment of the magnetic circuit of the solenoid valve is considerably reduced.

### SHORT DESCRIPTION OF THE DRAWING

An exemplary embodiment of the invention is described in detail hereinunder with reference to the accompanying drawing in which:

FIG. 1 shows a schematic cross-sectional illustration of a solenoid valve for controlling a fluid in accordance with a preferred exemplary embodiment of the invention.

### EMBODIMENT OF THE INVENTION

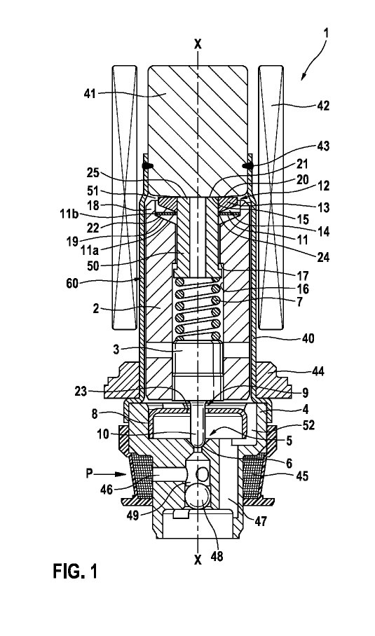

A solenoid valve for controlling a fluid in accordance with a preferred exemplary embodiment of the invention is described in detail hereinunder with reference to FIG. 1.

FIG. 1 shows a schematic cross-sectional illustration of a solenoid valve 1 for controlling a fluid in accordance with an exemplary embodiment of the invention. The solenoid valve 1 comprises a housing 40 fixed on a valve bushing 44 and inside said housing are arranged coaxially with respect to a central axis X an armature 2, a valve member 3 and also a valve body 4 that is connected to the housing 40. An armature assembly 60 comprises the armature 2, the valve member 3, a restoring element 7 and a plunger 50 that lies against an adjusting device 12, wherein a working gap 51 is provided between the armature 2 and the pole core 41. The pole core 41 is fastened to the housing 40 by means of a weld seam 43. As the solenoid valve 1 is actuated, the valve member 3 moves towards the pole core 41 in the direction of the central axis X and upon switching off the solenoid valve said valve member is returned to the starting position by virtue of the restoring element 7.

As is further evident from FIG. 1, a filter 45 is arranged on the outer face of the valve body 4. A fluid that is introduced through the filter 45 flows through a feed channel 46, which is embodied in the valve body 4 perpendicular with respect to the central axis X, in the direction of an arrow P into a through-going bore 49 that is embodied coaxially with respect to the central axis X. A plurality of outflow channels arranged coaxially in the peripheral direction are embodied in the valve body 4 in parallel with respect to the through-going bore 49, only one of said outflow channels being evident in FIG. 1 and being designated by the reference numeral 47. In addition, a bypass channel 52 is embodied in the valve body 4 for compensating the pressure between the outflow channel 47 in the valve body 4 and the armature 2 in the housing 40. A sphere 48 closes an end of the through-going bore 49, which end is facing away from the valve member 3. The end of the through-going bore 49, which end is facing the valve member 3, forms a through-going orifice 5 of the valve body 4 and comprises a valve seat 6. One end of a part region 10 of the valve member 3 lies on the valve seat 6 and closes the through-going orifice 5 when the solenoid valve 1 is in the de-energized operating state and/or, when the solenoid valve 1 is actuated, said end lifts off from the valve seat 6 and opens up said valve seat again. The part region 10 of the valve member 3 is movably guided through an orifice 9 of an impact device 8, wherein the impact device 8 is fixed in the valve body 4. An annular gap 23 to allow the valve member 3 to move unhindered is provided between the impact device 8 and the part region 10. The impact device 8 causes the fluid that is flowing in through the through-going orifice 5 to deflect by 180° in the direction towards the outflow channels 47. The solenoid valve 1 in accordance with the invention comprises in addition a plunger stage 12 that is embodied between the pole core 41 and the armature 2, which plunger stage comprises a plunger stage cutout 14 and a plunger stage element 13. As is further evident from FIG. 1, the plunger stage cutout 14 is embodied in so doing by an end face-side cutout in the armature 2 that comprises an outer cylindrical annular region 18 and an inner region 19 adjacent thereto, which inner region tapers in the direction towards the central axis X and/or is embodied in particular in a conical manner.

The plunger stage element 13 comprises a substantially planar end face 20 that faces the pole core 41 and ends flush with an end face 21 of the plunger 50. A side 22 of the plunger stage element 13, which side faces the armature 2, comprises a concave surface. The plunger stage element 13 is fixed to the plunger 50 by means of a press-fit connection. A generous concentricity tolerance is provided between the outer diameter of the plunger stage element 13 and the inner diameter of the annular region 18 of the plunger stage cutout 14 in order to ensure that the plunger stage element 13 is centered in the plunger stage cutout 14 even in the event of any possible tilting or radial displacement of the armature 2 with respect to the pole core 41.

The plunger 50 is arranged in the armature 2 in such a manner that said plunger can move in the axial direction, wherein the plunger 50 is secured to the armature 2 by means of a shoulder 17 in the central through-going bore 16, so that it is possible to achieve a pre-assembled armature assembly 60 that comprises the armature 2, the valve member 3, the restoring element 7 and the plunger 50. The armature assembly 60 comprises in addition a resilient element 11 that is arranged in the working gap 51 between the pole core 41 and the armature 2. The resilient element 11 that is embodied as a resilient disk or alternatively as a plate spring comprises a central orifice 24, through which is guided an end region 25 of the plunger 50. The end region 25 of the plunger 50 is in contact with a contact surface 15 of the pole core 41, which contact surface is spherical in order to compensate for a skew position of the pole core 41 and to prevent any resulting tilting of the armature assembly 60.

As is further evident from FIG. 1, the resilient element 11 lies with an inner periphery 11a on the side 22 of the plunger stage element 13, which side faces the armature 2, and said resilient element lies with an outer periphery 11b on the inner region 19 of the plunger stage cutout 14.

Sufficient free spaces into which the resilient element 11 can deform when the solenoid valve 1 is open are provided by virtue of the concave surface of the side of the plunger stage element 13, which side faces the armature, and by virtue of the concave inner region 19 of the plunger stage cutout 14. The specific contact positions of the resilient element 11 provide a desired, gradually progressive resilient characteristic curve that causes the valve to close. As a consequence, the characteristic curve of the in-parallel connected resilient element 11 together with the linear resilient characteristic curve of the restoring element 7 produces an overall progressive resilient characteristic curve, which functions in an opposite manner to the progressive magnetic force path.

The solenoid valve 1 in accordance with the invention has the advantage that, by means of the plunger stage 12 integrated in the armature assembly in addition to a sufficiently high magnetic force being achieved when the solenoid valve 1 is closed, a substantially linear magnetic force path is achieved over the entire valve stroke range, which considerably improves the continuous (proportional) adjustability of the solenoid valve 1 and achieves a more precise accuracy of functioning in all operating points. The plunger stage geometry that is used ensures that the plunger stage functions in an operationally reliable manner even if there is any tilting or axis displacement of the armature assembly.

1. A solenoid valve for controlling a fluid, comprising:
an armature,
a pole core, the armature and the pole core defining a working gap therebetween,
a valve member connected to the armature and configured to move together with the armature,
a valve body defining a through-going orifice, on which a valve seat is configured, the valve member being configured to open up and close off the through-going orifice on the valve seat,
a restoring element configured to exert a restoring force on the valve member in order to restore the valve member to a closed state, the armature defining a central through-going bore for receiving the valve member and the restoring element, and
a plunger stage located between the pole core and the armature.

2. The solenoid valve as claimed in claim 1, wherein the plunger stage comprises a plunger stage cutout and a plunger stage element.

3. The solenoid valve as claimed in claim 2, wherein the armature, the valve member, the restoring element and a plunger form a pre-assembled armature assembly, and wherein the plunger stage element arranged on the plunger and the plunger stage cutout is configured on the armature by virtue of an end face-side cutout.

4. The solenoid valve as claimed in claim 3, wherein the plunger stage element is connected to the plunger by a press-fit connection.

5. The solenoid valve as claimed in claim 1, in addition further comprising a resilient element arranged between the pole core and the armature.

6. The solenoid valve as claimed in claim 5, wherein the resilient element is part of the pre-assembled armature assembly.

7. The solenoid valve as claimed in claim 1, wherein the plunger stage comprises a double plunger stage or a cone plunger stage.

8. The solenoid valve as claimed in claim 1, characterized in that wherein a contact surface of the pole core is configured in a spherical manner in a direction towards the plunger stage element.

9. The solenoid valve as claimed in claim 1, further comprising an impact disk configured to deflect fluid when the solenoid valve is open, wherein a part region of the valve member is guided through a central orifice in the impact disk.

10. The solenoid valve as claimed in claim 2, wherein the plunger stage cutout is configured in a tapered manner.

11. The solenoid valve as claimed in claim 2, wherein the plunger stage element comprises a concave surface that is directed towards the armature.

12. The solenoid valve as claimed in claim 10, wherein the plunger stage cutout is configured in a conical manner.
